(19) United States
(12) Patent Application Publication
(10) Pub. No.: US 2024/0015087 A1
(43) Pub. Date: Jan. 11, 2024

(54) HIGH FREQUENCY PROBING FOR MICRO-FAILURE DETECTION ON SENSITIVE NETWORK PATHS

(71) Applicant: Cisco Technology, Inc., San Jose, CA (US)

(72) Inventors: Grégory Mermoud, Venthône (CH); Jean-Philippe VASSEUR, Saint Martin d’Uriage (FR); Vinay Kumar KOLAR, San Jose, CA (US); Michal Wladyslaw GARCARZ, Krakow (PL); Andrzej MIECZKOWSKI, Kraków (PL)

(21) Appl. No.: 17/858,269

(22) Filed: Jul. 6, 2022

(51) Int. Cl. H04L 43/0811; H04L 43/12; H04L 43/087; G06N 20/00

(52) U.S. Cl. CPC H04L 43/0811; H04L 43/12; H04L 43/087; G06N 20/00

(57) ABSTRACT

In one embodiment, a device obtains telemetry data associated with application traffic for an online application. The device identifies, based on the telemetry data, a network path as potentially exhibiting transient events during which a performance metric of the network path is degraded that are undetected at a first probing frequency for the network path. The device determines a new probing frequency for the network path, to detect the transient events. The device causes probes to be sent along the network path according to the new probing frequency.

### TECHNICAL FIELD

The present disclosure relates generally to computer networks, and, more particularly, to high frequency probing for micro-failure detection on sensitive network paths.

### BACKGROUND

Software-defined wide area networks (SD-WANs) represent the application of software-defined networking (SDN) principles to WAN connections, such as connections to cellular networks, the Internet, and Multiprotocol Label Switching (MPLS) networks. The power of SD-WAN is the ability to provide consistent service level agreement (SLA) for important application traffic transparently across various underlying tunnels of varying transport quality and allow for seamless tunnel selection based on tunnel performance characteristics that can match application SLAs and satisfy the quality of service (QoS) requirements of the traffic (e.g., in terms of delay/latency, jitter, packet loss, etc.).

Application-aware routing used in SD-WANs typically relies on probing of the network paths used by traffic for a particular application, to detect and mitigate against SLA violations. To do so, a tradeoff is often made with respect to the probing frequency so as not to impinge on the application traffic sent via the path. A potential consequence of this, though, are undetected “micro-failures” in which the QoS requirements of the traffic are temporarily not met, but return to acceptable before the next path probe. While transient in nature, such micro-failures can also impact the quality of experience of the online application from the perspective of its users.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIGS. 5A-5B illustrate example plots of micro-failures in a network path;

FIG. 6 illustrates an example architecture for detecting micro-failures by a network path; and

FIG. 7 illustrates an example simplified procedure for identifying a network path to be probed for micro-failures.

### DESCRIPTION OF EXAMPLE EMBODIMENTS

### Overview

According to one or more embodiments of the disclosure, a device obtains telemetry data associated with application traffic for an online application. The device identifies, based on the telemetry data, a network path as potentially exhibiting transient events during which a performance metric of the network path is degraded that are undetected at a first probing frequency for the network path. The device determines a new probing frequency for the network path, to detect the transient events. The device causes probes to be sent along the network path according to the new probing frequency.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

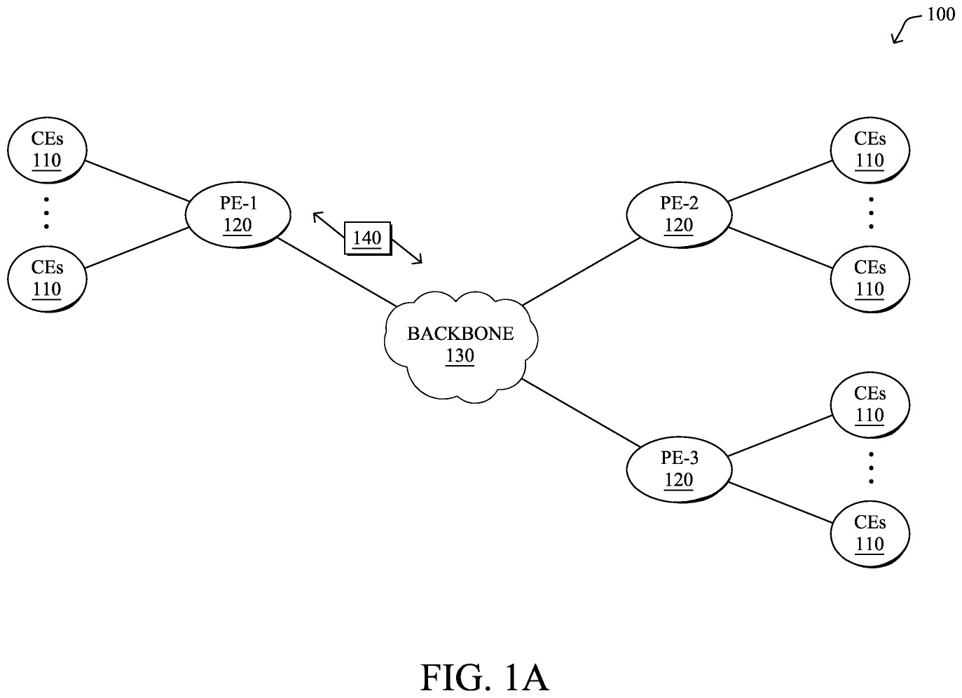

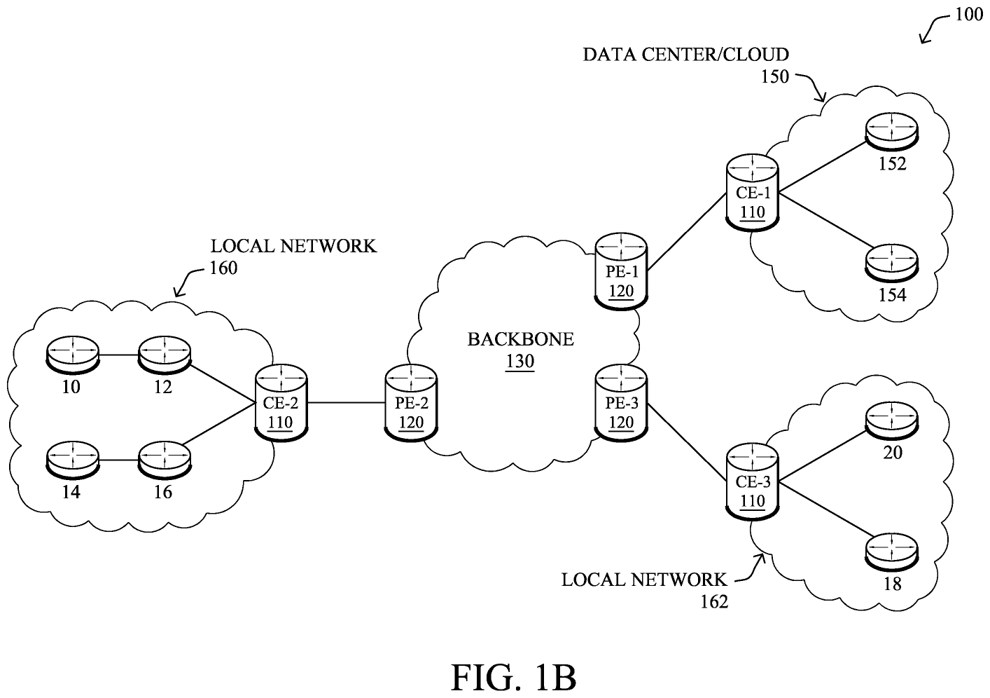

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

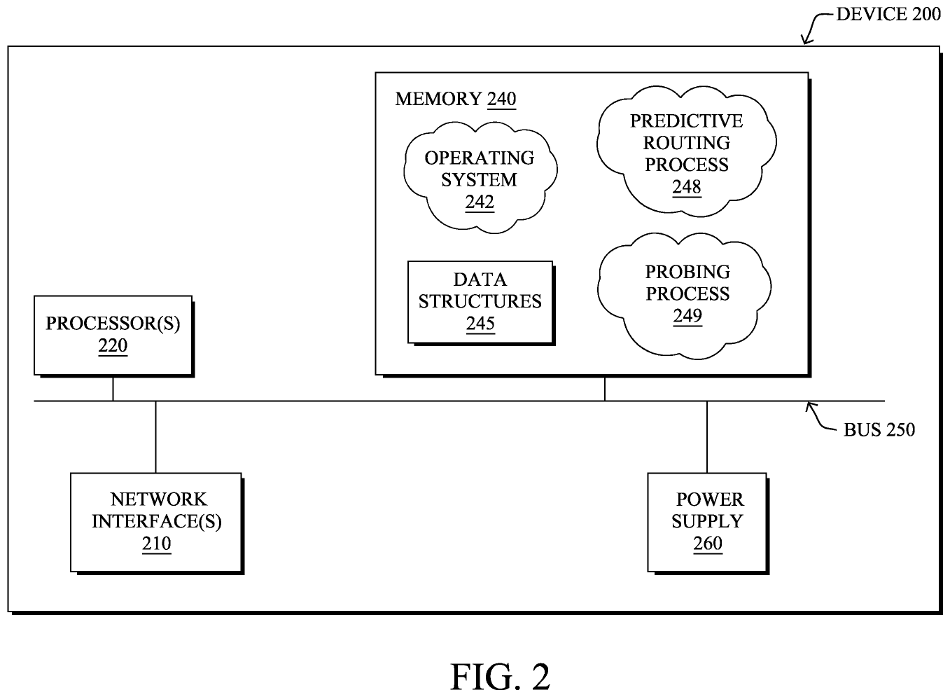

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive routing process 248 and/or a probing process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, predictive routing process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, predictive routing process 248 and/or a probing process 249 may include computer executable instructions that, when executed by processor(s) 220, cause device 200 to perform the techniques described herein. To do so, in some embodiments, predictive routing process 248 and/or a probing process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive routing process 248 and/or a probing process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive routing process 248 and/or a probing process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

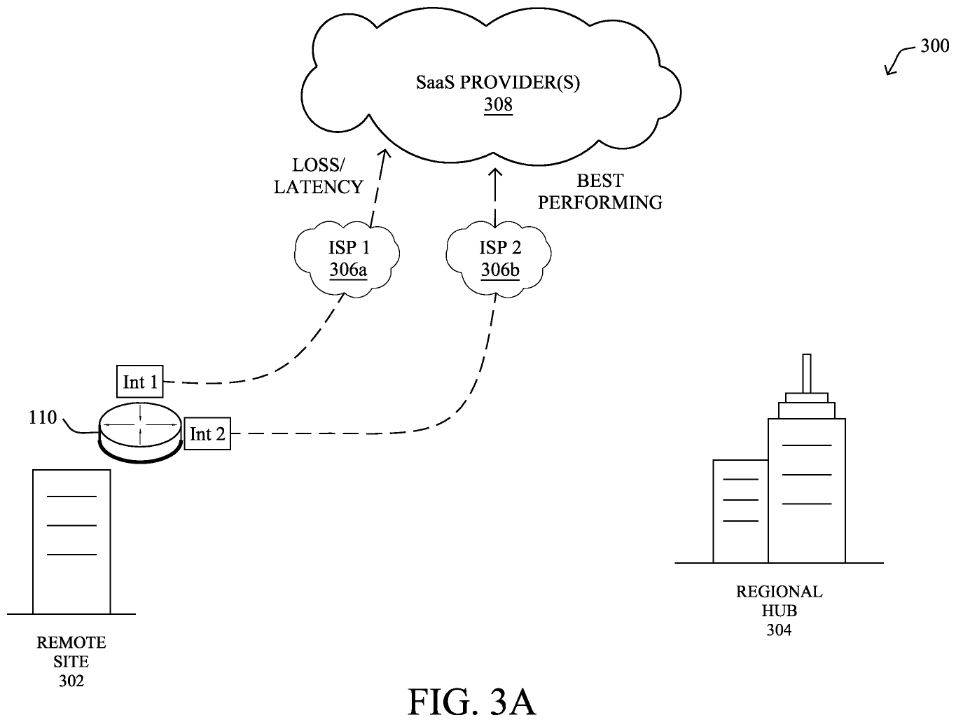

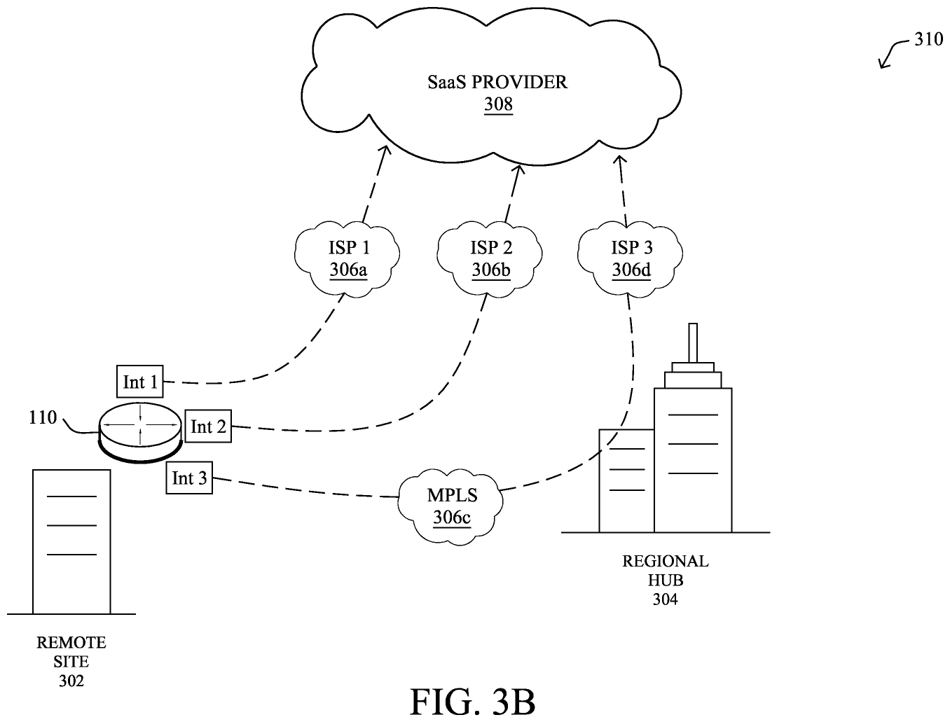

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL. 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

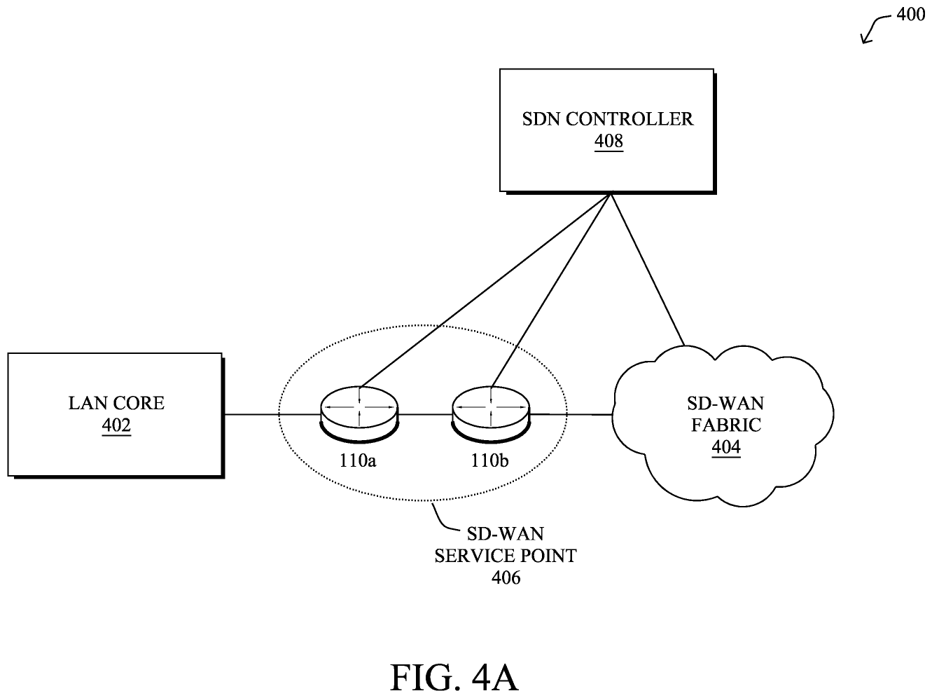

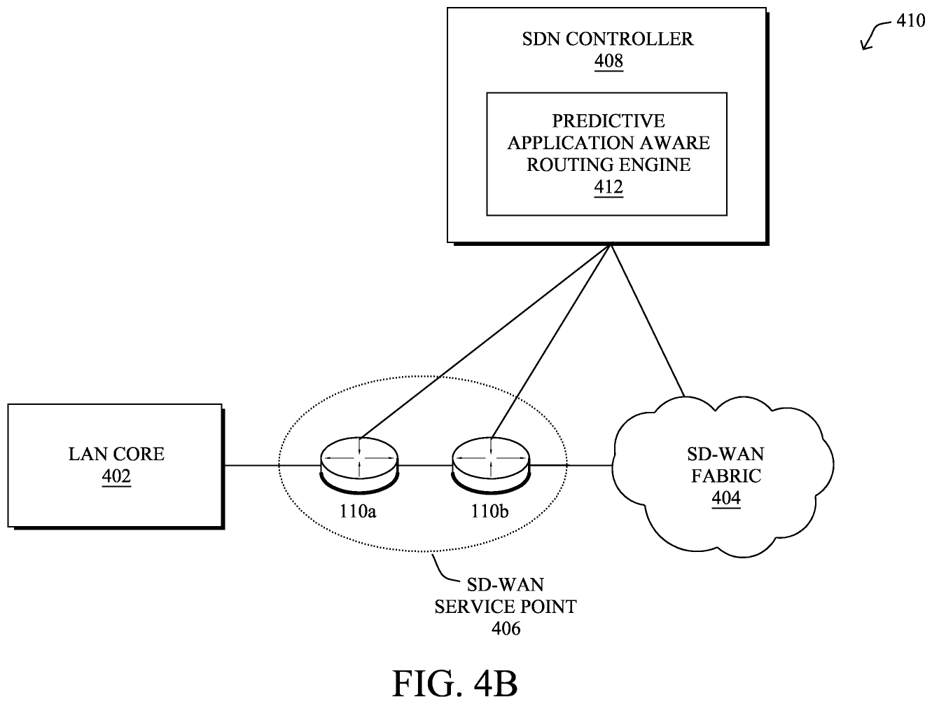

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance. SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance. SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side. SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive routing process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As would be appreciated, modern SaaS applications are delivered globally via public cloud infrastructure using cloud native services. Even though public cloud providers may have a high number of points of presence (PoPs) and use those to deliver the application, globally. Still, testing has shown that user quality of experience (QoE) may vary greatly based on the location of the user. This is because all public cloud providers are delivering services which are region-based and applications are running in specific region(s) and location(s). Indeed, even though it might seem that an online application is global (e.g., because of its use of globally-available CloudFront POPs, etc.), in reality it might run in a single region/location and user experience might vary greatly based on the location.

To determine the QoE for a particular SaaS application, various approaches are possible such as:
Obtaining user feedback directly from the application
Applying traffic analytics, such as by analyzing Netflow records that include extra metrics like Application Response Time (ART)
Sending synthetic path probes to measure networking metrics to each SaaS application from each location. These probes are ‘synthetic’ in that they seek to mimic the actual characteristics of the traffic of the application under scrutiny.

The first approach above is rarely used today because of its complexity. In addition, relying on direct user feedback to drive routing decisions also requires supporting application programming interfaces (APIs) and the relevant network telemetry, in order to optimize the routing. The second and third approaches above are well-suited for use in Secure Access Service Edge (SASE)/SD-WAN implementations. In various embodiments, predictive application aware routing engine 412 may make use of any or all of the above approaches.

As would be appreciated, a tradeoff is often made with respect to the probing frequency so as not to impinge on the application traffic sent via the path. A potential consequence of this, though, are undetected “micro-failures” in which the QoS requirements of the traffic are temporarily not met (e.g., in terms of delay/latency, jitter, loss, throughput, etc.), but return to acceptable before the next path probe. While transient in nature, such micro-failures can also impact the quality of experience of the online application from the perspective of its users. Indeed, micro-failures are one of the importance causes of voice and video applications to provide poor QoE.

There are various potential causes for micro-failures, either due to the application itself or due to the operation of the network. In both cases, the underlying cause is often a temporary lack of adequate resources. For instance, the network path conveying the application traffic may experience a temporary lack of bandwidth, congestion, or the like. On the application side, a micro-failure could also be due to a temporary lack of compute resources, memory, or the like, at the application server.

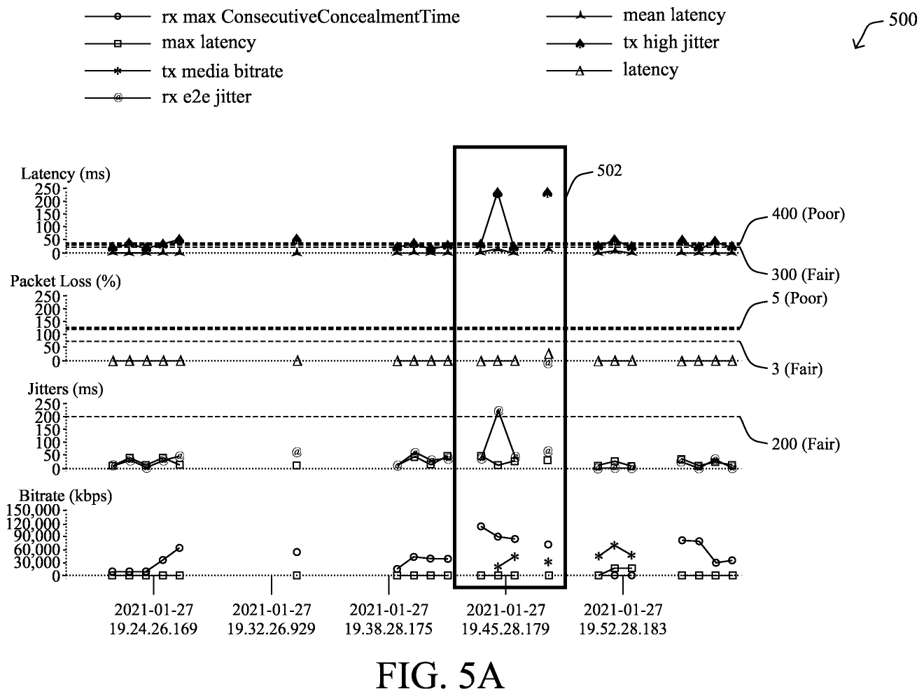

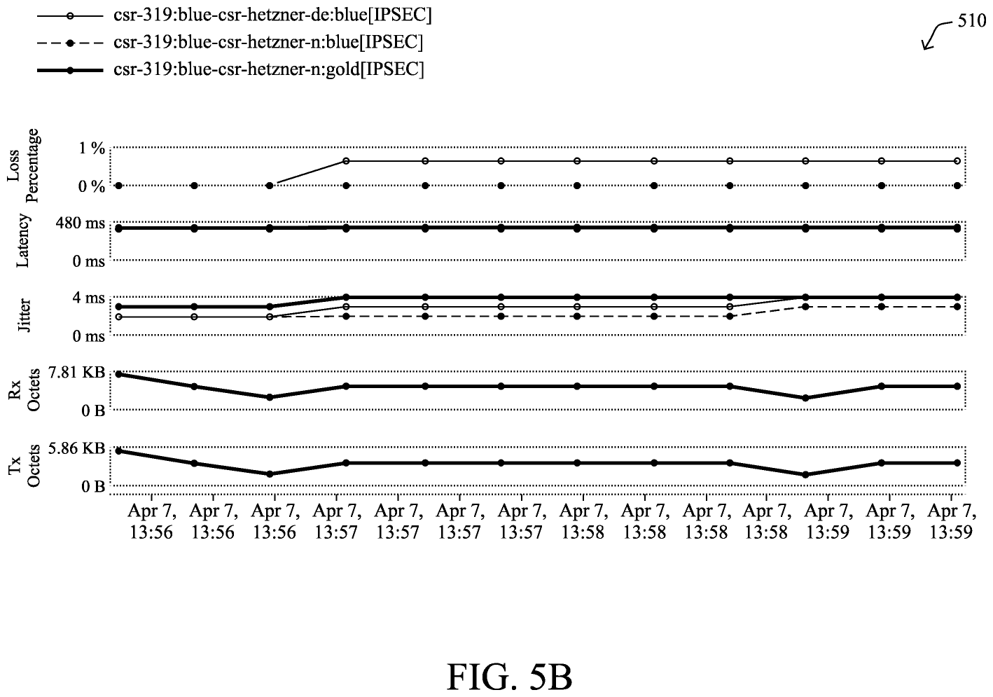

FIGS. 5A-5B illustrate example plots of micro-failures in a network path, according to various embodiments. More specifically, FIG. 5A illustrates an example plot 500 of the latency, packet loss, jitter, and bitrate/throughput measured over time along a network path by a client of a videoconferencing application. Here, the following information is highlighted:
latency
max latency
mean latency
transmit (tx) high packetLoss
receive (rx) end-to-end (e2e) packetLoss
rx high packetLoss
tx high jitter
rx e2e jitter
tx media bitrate
rx media bitrate
tx available bitrate
rx available bitrate
rx concealmentTime
rx max ConsecutiveConcealmentTime

Here, it can be seen that during a single timeframe 502, the latency and jitter spikes. This spike lasts less than 60 seconds, but has a significant impact on the end user experience. It is not rare to have a series of such micro-failures or even many (periodic) micro-failures during the whole call. Also, most of the time, micro-failures are of a very short duration (e.g., between 500 ms and 5 seconds).

Unfortunately, most applications and network solutions are unable to detect temporary failures of short duration, simply because telemetry polling operates at a different granularity. For example, ThousandEyes sends a probe every minute. Furthermore, even when higher granularity is available, most variables are aggregated, such as by using averaged values over a specific time frame to decrease costs and resource constraints). For instance, some SD-WAN solutions measure loss, jitter, and latency on a tunnel by using a time window of ten minutes and averaging the results from six hundred probes that are sent at a probing frequency of very second.

FIG. 5B illustrates a plot 510 of the loss percentage, latency, jitter, received octets, and transmitted octets in an SD-WAN. As can be seen, micro-failures that are 500 ms long remain undetected (averaging over 60 seconds).

As discussed above, it is not possible to probe every network path at the level of granularity/frequency required to detect every micro-failure, mostly because of costs and resource constraints.

High Frequency Probing for Micro-Failure Detection on Sensitive Network Paths

The techniques herein introduce mechanisms to perform selective, high frequency probing of specific network paths of interest that are suspected of exhibiting micro-failures that remain undetected due to the current probing frequency in use. In some aspects, the paths may be selected based on telemetry data obtained from the network and/or the online application. In further aspects, a machine learning model (e.g., a classifier) may be trained to use the telemetry data to identify which paths are likely to be exhibiting micro-failures. In turn, probing at a higher probing frequency can be initiated along those paths, so that the micro-failures can actually be detected along those paths.

Illustratively, the techniques described herein may be performed by hardware, software, and/or firmware, such as in accordance with probing process 249, which may include computer executable instructions executed by the processor 220 (or independent processor of interfaces 210) to perform functions relating to the techniques described herein, in conjunction with predictive routing process 248.

Specifically, according to various embodiments, a device obtains telemetry data associated with application traffic for an online application. The device identifies, based on the telemetry data, a network path as potentially exhibiting transient events during which a performance metric of the network path is degraded that are undetected at a first probing frequency for the network path. The device determines a new probing frequency for the network path, to detect the transient events. The device causes probes to be sent along the network path according to the new probing frequency.

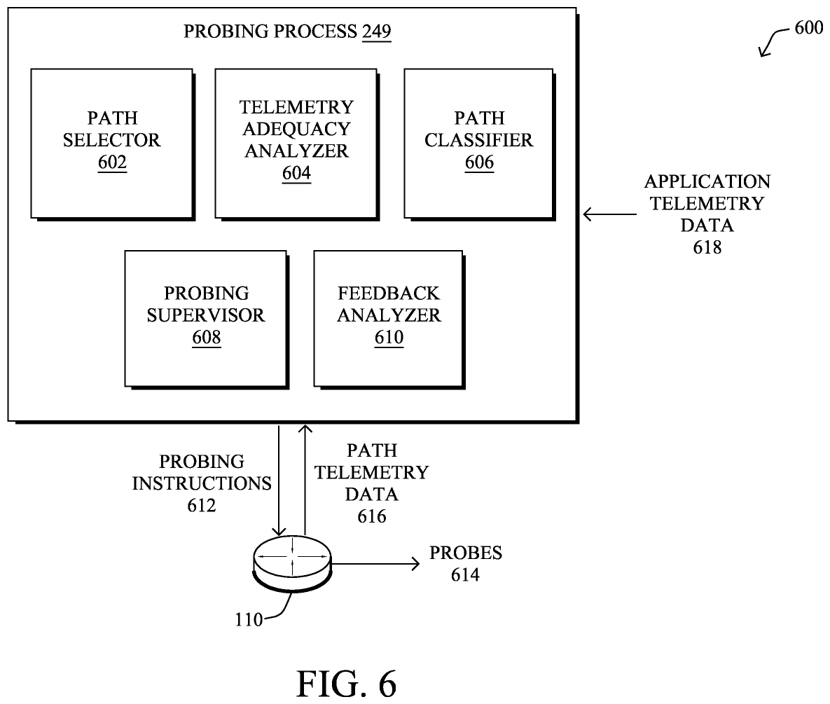

Operationally, FIG. 6 illustrates an example architecture for detecting micro-failures by a network path, according to various embodiments. At the core of architecture 600 is probing process 249, which may be executed by a controller for a network or another device in communication therewith. For instance, probing process 249 may be executed by a controller for a network (e.g., SDN controller 408 in FIGS. 4A-4B), a particular networking device in the network (e.g., a router, etc.), another device or service in communication therewith, or the like, to provide a supervisory service to the network. More specifically, probing process 249 may operate in conjunction with a predictive application aware routing engine, such as predictive application aware routing engine 412, or directed implemented as a component thereof, in some embodiments.

As shown, probing process 249 may include any or all of the following components: a path selector 602, a telemetry adequacy analyzer 604, a path classifier 606, a probing supervisory 608, and/or a feedback analyzer 610. As would be appreciated, the functionalities of these components may be combined or omitted, as desired. In addition, these components may be implemented on a singular device or in a distributed manner, in which case the combination of executing devices can be viewed as their own singular device for purposes of executing probing process 249.

In various embodiments, path selector 602 is responsible for selecting the set of paths that are highly susceptible to experiencing micro-failures, thus requiring high frequency probing. To do so, path selector 602 may assess path telemetry data 616 and/or application telemetry data 618 that probing process 249 may obtain either on a push or pull basis. For instance, path telemetry data 616 may include probing results from sending probes along one or more paths in the network, such as SD-WAN probes, ThousandEyes probes, or the like, that probing process 249 may obtain from a networking device such as router 110, another networking device, or a device in communication therewith. Such path telemetry data 616 may, for instance, indicate the path metrics (e.g., delay/latency, loss, jitter, throughput, etc.) measured along a given network path through probing at a certain probing frequency. Similarly, application telemetry data 618 may be obtained from the online application whose traffic is sent via the network path, such as from an application server or client/dedicated agent of the application.

One observation herein is that it may be possible to infer the occurrence of undetected micro-failures through the analysis of the available telemetry data. For instance, consider the example of an SD-WAN tunnel that is typically reporting an average latency of 50 ms every minute but, at some point, increases to 100 ms while seeing its jitter increasing significantly. Such symptoms might suggest that the latency increase was not distributed equally across the one minute interval but instead spiked temporarily to a value much superior to 100 ms, resulting in significant jitter.

In another example, path selector 602 may assess the maximum concealment time reported as part of application telemetry data 618. In general, the maximum concealment time measures the longest interval during which the audio/video codec of the application could not produce a meaningful audio/video stream. Such a metric from the application is usually a clear sign of intermittent networking issues (e.g., packet loss) which, being consecutive, prevent the codec from recovering the flow. This leads to the QoE of the application being impacted, despite not being detected by measurements techniques averaged over a long period of time.

Path selector 602 may identify the occurrence of potential micro-failures and assign a confidence value to them. For instance, the higher the confidence value, the more path selector 602 is certain of the presence of one or more micro-failures along a given network path. In further embodiments, path selector 602 may also group the potential micro-failures into sets of different classes. For instance, each class may consist of a set of parameters or attributes of a micro-failure such as any or all of the following: min/max latency, min/max loss, min/max jitter, duration, periodicity, etc.

In yet another embodiment, path selector 602 may receive input from a user interface indicative which path(s) a network administrator considers important. For instance, such input may flag a given path as critical or specify the condition(s) to use to identify paths of interest. For example, a certain path may be considered important based on the type(s) of traffic that it conveys, its volume of traffic, etc. In addition, the administrator may also be able to specify the level of confidence associated with the inferences by path selector 602 before initiating high-frequency probing of that path. For instance, one such rule may specify that high-frequency probing should be initiated for a path X if it conveys voice/video traffic, for more than x Mbps, and the number of suspected micro-failures exceeds 0.5 micro-failures/hour).

In yet another embodiment, path selector 602 may send a message to the cloud indicative of which paths may be exhibiting undetected micro-failures. For example, assume that BFD probing is used in an SD-WAN every second and the resulting metric(s) later aggregated at a coarser granularity and stored. This can be achieved, for instance, by maintaining counters on the variation of a path metric at the second level for each tunnel in the SD-WAN. In turn, probing process 249 may send a notification regarding the identified tunnels/paths that are likely to have micro-failures for use by another device and/or for presentation to a user.

In various embodiments, telemetry adequacy analyzer 604 is responsible for suggesting when/where currently available telemetry (e.g., path telemetry data 616 and/or application telemetry data 618) is not sufficient (or not) to detect suspected micro-failures. For example, path selector 602 may suspect the presence of a micro-failure on a specific path with a low to moderate confidence value, but without being able to confirm with the current telemetry. As a result, telemetry adequacy analyzer 604 may suggest reconfiguring the SD-WAN fabric to increase the telemetry granularity for a short period of time, such as by increasing the probing frequency. Note that suggestion by telemetry adequacy analyzer 604 could also be the opposite (e.g., a proposal to decrease the probing frequency on a certain path). In some embodiments, probing process 249 may automatically implement the suggestions by telemetry adequacy analyzer 604. However, in other embodiments, telemetry adequacy analyzer 604 may first present the suggested changes for display to a network administrator or other user, to receive confirmation of the changes, before implementing them in the network (e.g., by increasing the probing frequency along a certain path).

In general, telemetry adequacy analyzer 604 may base its decisions on the results of analyzing a large number of paths across different tunnels, entities, or the like (e.g., based on the observation of very specific tunnel of corporation X, it is possible to generate a recommendation for similar tunnel used by this corporation). That similarity might be achieved using clustering methods using attributes specific to the tunnel like performance patterns, traffic usage, entropy, failures, events, alarms, etc. The objective here is not only to detect a micro-failure but gather enough details to be able to classify it to the right class. That is important because different classes of micro-failure will impact different applications differently. For example, 500 ms failures spiking every five seconds with latency and jitter values to 400 ms will impact WebEx more seriously then 1000 ms failures spiking every ten seconds with a latency value of 500 ms.

In various embodiments, path classifier 606 may take the form a machine learning model in charge of classifying a given network path. For instance, the following classes/categories may be used by path classifier 606 to label a given network path:
High: high probability of a micro-failure along the path
Medium: medium probability of a micro-failure along the path
Low: low probability of a micro-failure along the path

Of course, fewer categories (e.g., just ‘high’ and ‘low’) or more categories could also be used, as desired. Here, a first pass may be made using all paths enabled with high frequency probing so as to build a training set of samples for each category (high, medium, low). The global dataset is then used to train the classifier of path classifier 606 using the path attributes with low granularity, in addition to other path characteristics such as the type of path (e.g., number of hops, types of links (if available), aggregated network KPI (delay, loss, latency), set of traversed autonomous systems/service providers, and the like. Various types of classifiers can be used to implement path classifier 606 such as (deep) neural networks or any other suitable form of classifier. The overall precision/recall of the model can also be used to compute the level of confidence of the classifier.

In various embodiments, probing supervisory 608 may be responsible for overseeing the operation of probing engines across the network. To that end, a custom probing instructions message 612 is introduced herein to implement the change(s) suggested by telemetry adequacy analyzer 604. For instance, custom probing instructions message 612 may cause router 110 to send probes 614 along a certain network path at an indicated probing frequency that is greater than that currently used to probe the path.

Probing supervisory 608 may also send custom probing instructions message 612 based in part on an instruction from an administrator to do so, such as after probing process 249 reports the suggested changes and reasons for review (e.g., suspicion of the presence of micro-failures impacting the user experience that are not current detected by the existing telemetry). For instance, one such change may be to reconfigure the SD-WAN to use BFD probes every 100 ms on a certain path/tunnel, instead of every second.

According to various embodiments, feedback analyzer 610 may implement a feedback loop used to validate whether the path classification is indeed correct or whether the high frequency probing enabled to detect micro-failures by that path should be disabled. To do so, when high frequency probing is activated, feedback analyzer 610 may start a configurable timer in charge of monitoring the rate at which micro-failures are indeed detected according to the class for the path (e.g., High, Medium, or Low). The distribution for the micro-failure class (in pass one) may then be used by feedback analyzer 610 to determine whether the path indeed belongs to the class. If not, plot 510 may take corrective measures such as notifying the network administrator via a user interface, deactivating the high frequency probing (e.g., by sending a new custom probing instructions message 612), or initiating the classification model of path classifier 606.

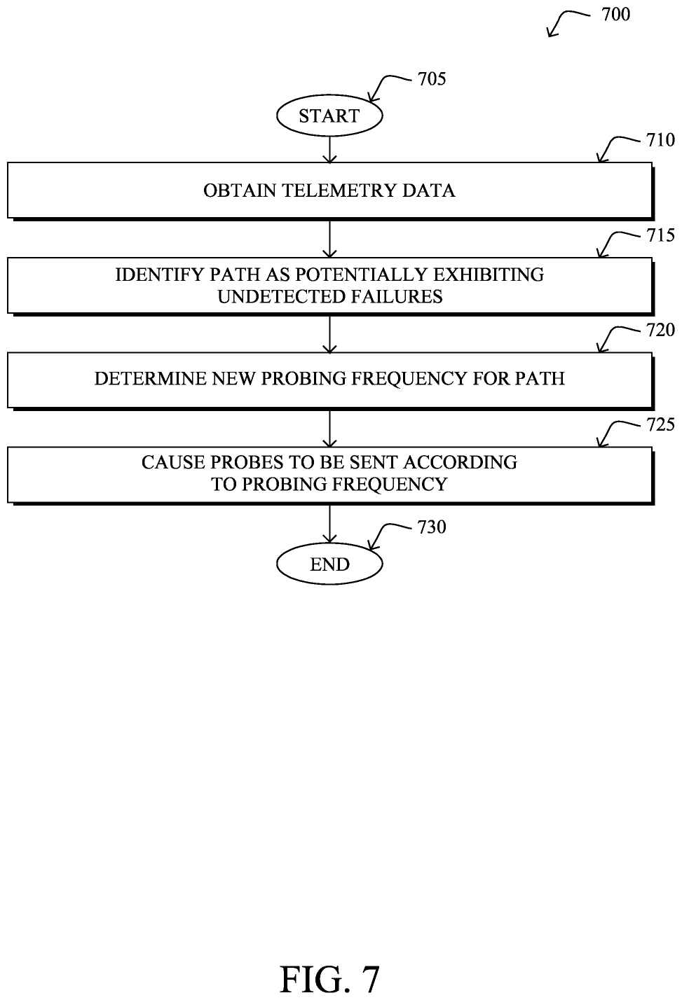

FIG. 7 illustrates an example simplified procedure 700 (e.g., a method) procedure for identifying a network path to be probed for micro-failures, in accordance with one or more embodiments described herein. For example, a non-generic, specifically configured device (e.g., device 200), such as controller for a network (e.g., an SDN controller or other device in communication therewith), may perform procedure 700 by executing stored instructions (e.g., probing process 249), to provide a supervisory service to a network. The procedure 700 may start at step 705, and continues to step 710, where, as described in greater detail above, the device may obtain telemetry data associated with application traffic for an online application. In some embodiments, the telemetry data comprises results from probing the network path at the first probing frequency. For instance, the telemetry data may indicate the measured packet loss, latency, jitter, throughput, etc. of the path over a given time period. In other embodiments, the device may obtain the telemetry data from the online application (e.g., maximum concealment time information, etc.).

At step 715, as detailed above, the device may identify, based on the telemetry data, a network path as potentially exhibiting transient events during which a performance metric of the network path is degraded that are undetected at a first probing frequency for the network path. In one embodiment, the device may identify the network path in part based on input from a user interface designating the network path as important (e.g., of interest, critical, based on the type of traffic carried by the path, etc.). In some embodiments, the performance metric is of a different type than one or more performance metrics in the telemetry data on which identification of the network path is based. For instance, the device may infer that undetected micro-failures are occurring in the latency of the path, based on the jitter actually observed along the path. In another example, the maximum concealment time of the application may indicate undetected micro-failures in the packet loss along the path. In additional embodiments, the device may identify the network path using a machine learning classifier to classify the network path. In a further embodiment, the device may also obtain feedback regarding the probes sent along the network path according to the new probing frequency and update the machine learning classifier based on the feedback.

At step 720, the device may determine a new probing frequency for the network path, to detect the transient events, as described in greater detail above. More specifically, if the network path is suspected of exhibiting undetected micro-failures, the new probing frequency may be set so as to probe the network path more frequently than the current/first probing frequency.

At step 725, as detailed above, the device may cause probes to be sent along the network path according to the new probing frequency. In some embodiments, the device may send an instruction to a networking device associated with the network path that indicates the new probing frequency. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for high frequency probing for micro-failure detection on sensitive network paths, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, telemetry data associated with application traffic for an online application;
identifying, by the device and based on the telemetry data, a network path as potentially exhibiting transient events during which a performance metric of the network path is degraded that are undetected at a first probing frequency for the network path;
determining, by the device, a new probing frequency for the network path, to detect the transient events; and
causing, by the device, probes to be sent along the network path according to the new probing frequency.

2. The method as in claim 1, wherein the telemetry data comprises results from probing the network path at the first probing frequency.

3. The method as in claim 1, wherein the device obtains the telemetry data from the online application.

4. The method as in claim 1, wherein the device identifies the network path in part based on input from a user interface designating the network path as important.

5. The method as in claim 1, wherein the performance metric is of a different type than one or more performance metrics in the telemetry data on which identification of the network path is based.

6. The method as in claim 1, wherein the device identifies the network path using a machine learning classifier to classify the network path.

7. The method as in claim 6, further comprising:
obtaining, by the device, feedback regarding the probes sent along the network path according to the new probing frequency; and
updating, by the device, the machine learning classifier based on the feedback.

8. The method as in claim 1, further comprising:
providing, by the device, the new probing frequency for display.

9. The method as in claim 1, wherein the telemetry data is indicative of at least one of: packet loss, latency, jitter, or throughput.

10. The method as in claim 1, wherein the telemetry data is indicative of a maximum concealment time for the online application.

11. The method as in claim 1, wherein the device causes probes to be sent along the network path according to the new probing frequency by:
sending an instruction to a networking device associated with the network path that indicates the new probing frequency.

12. An apparatus, comprising:
one or more network interfaces;
a processor coupled to the one or more network interfaces and configured to execute one or more processes; and
a memory configured to store a process that is executable by the processor, the process when executed configured to:
obtain telemetry data associated with application traffic for an online application;
identify, based on the telemetry data, a network path as potentially exhibiting transient events during which a performance metric of the network path is degraded that are undetected at a first probing frequency for the network path;
determine a new probing frequency for the network path, to detect the transient events; and
cause probes to be sent along the network path according to the new probing frequency.

13. The apparatus as in claim 12, wherein the telemetry data comprises results from probing the network path at the first probing frequency.

14. The apparatus as in claim 12, wherein the apparatus obtains the telemetry data from the online application.

15. The apparatus as in claim 12, wherein the apparatus identifies the network path in part based on input from a user interface designating the network path as important.

16. The apparatus as in claim 12, wherein the performance metric is of a different type than one or more performance metrics in the telemetry data on which identification of the network path is based.

17. The apparatus as in claim 12, wherein the apparatus identifies the network path using a machine learning classifier to classify the network path.

18. The apparatus as in claim 12, wherein the process when executed is further configured to:
provide the new probing frequency for display.

19. The apparatus as in claim 12, wherein the apparatus causes probes to be sent along the network path according to the new probing frequency by:
sending an instruction to a networking device associated with the network path that indicates the new probing frequency.

20. A tangible, non-transitory, computer-readable medium storing program instructions that cause a device to execute a process comprising:
obtaining, by the device, telemetry data associated with application traffic for an online application;
identifying, by the device and based on the telemetry data, a network path as potentially exhibiting transient events during which a performance metric of the network path is degraded that are undetected at a first probing frequency for the network path;
determining, by the device, a new probing frequency for the network path, to detect the transient events; and
causing, by the device, probes to be sent along the network path according to the new probing frequency.
